(19) United States
(12) Patent Application Publication
(10) Pub. No.: US 2001/0054396 A1
(43) Pub. Date: Dec. 27, 2001

(54) W9-nine cylinder engine

(76) Inventor: Robert David Hurt, San Diego, CA (US)

Correspondence Address: Robert David Hurt, 10030 Tree Haven Court, San Diego, CA, 92131, US

(21) Appl. No.: 09/732,083

(22) Filed: Dec. 8, 2000

Related U.S. Application Data
(60) Provisional application No. 60/168,440, filed on Dec. 2, 1999.

(51) Int. Cl. F02B 75/22

(52) U.S. Cl. 123/54.4; 123/54.8

(57) ABSTRACT

Abstract This engine configuration is a crankshaft driven semi-radial piston engine having three banks of three cylinders. It resembles a V-six but has an additional bank of three cylinders centered on a plane dividing the in-line V symmetrically in half through the crankshaft axis. Either outside bank of three cylinders would form a V-six type engine, taken together with the middle bank. The crankshaft has throws at 120 degrees between the nodes with all pistons in a particular in-line bank connected to the crankshaft at a different throw angle. Each cylinder contains one piston that connects to the crankshaft via a typical conecting rod. All pistons in one in-line bank connect to a different node throw angle. Starting with any piston at its TDC position, each 40 degrees will bring a different piston to its TDC position until 360 degrees of crankshaft rotation brings the first back to its TDC position.

### Description

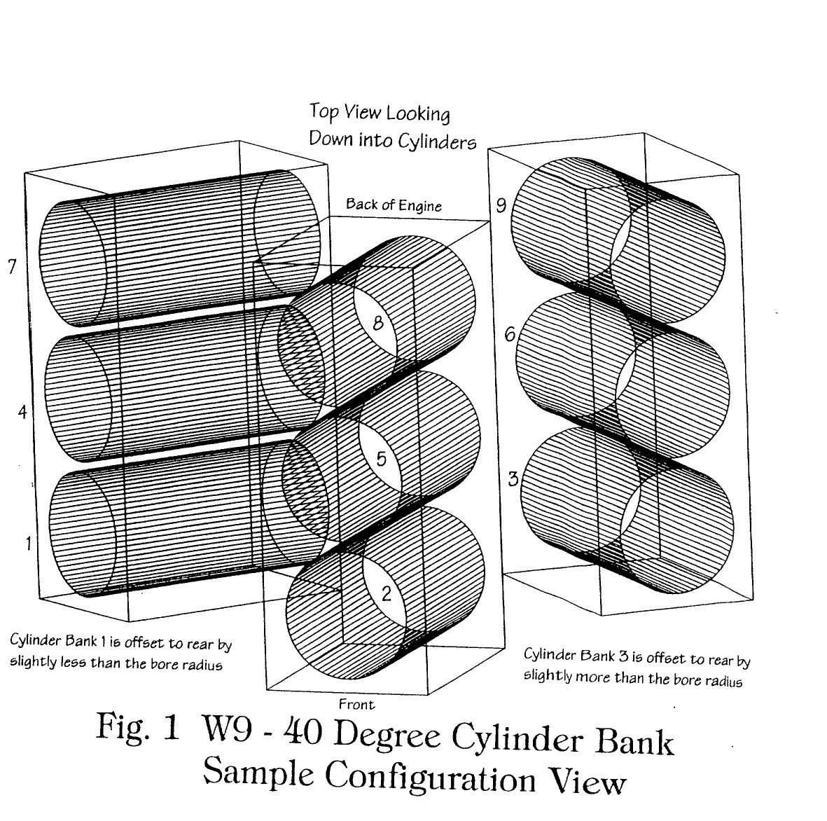

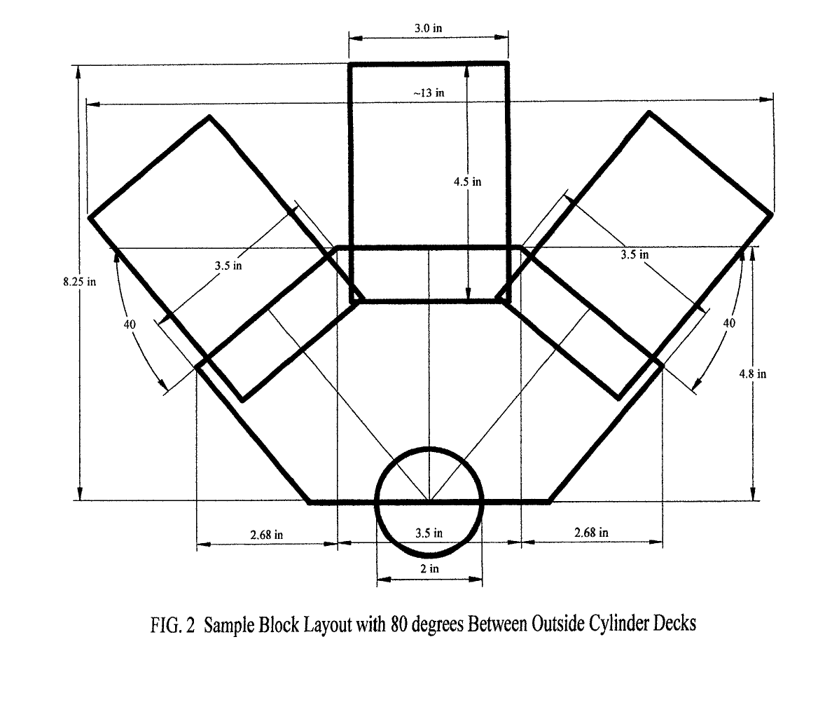

This engine is a piston type semi-radial engine that has three radial banks of three cylinders each. It is configured most closely to an 80 degree bank angle V-six type engine with an additional bank of three in-line cylinders centered at the 40 degree midpoint between the two outside cylinder banks. Thus, the plane including the three parallel axes of center cylinder bank appears to divide the 80 degree V-6 symmetrically into half. Either outside bank of three cylinders would therefore form a V-six type engine when taken together with the middle bank of three cylinders. Taken two at a time, a flat plane passing through the axes of each cylinder in one bank, would intersect the geometric plane containing the axes of the adjacent bank along a single line parallel to the centerline of the crankshaft or exactly at the centerline of the crankshaft. FIG. 1 shows this shape pictorially.

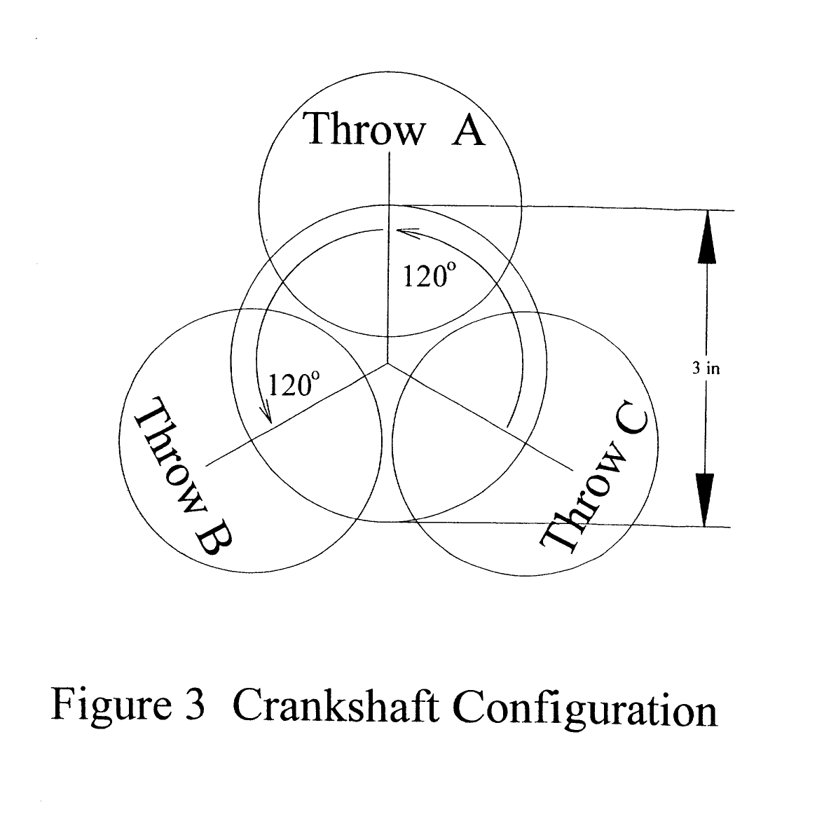

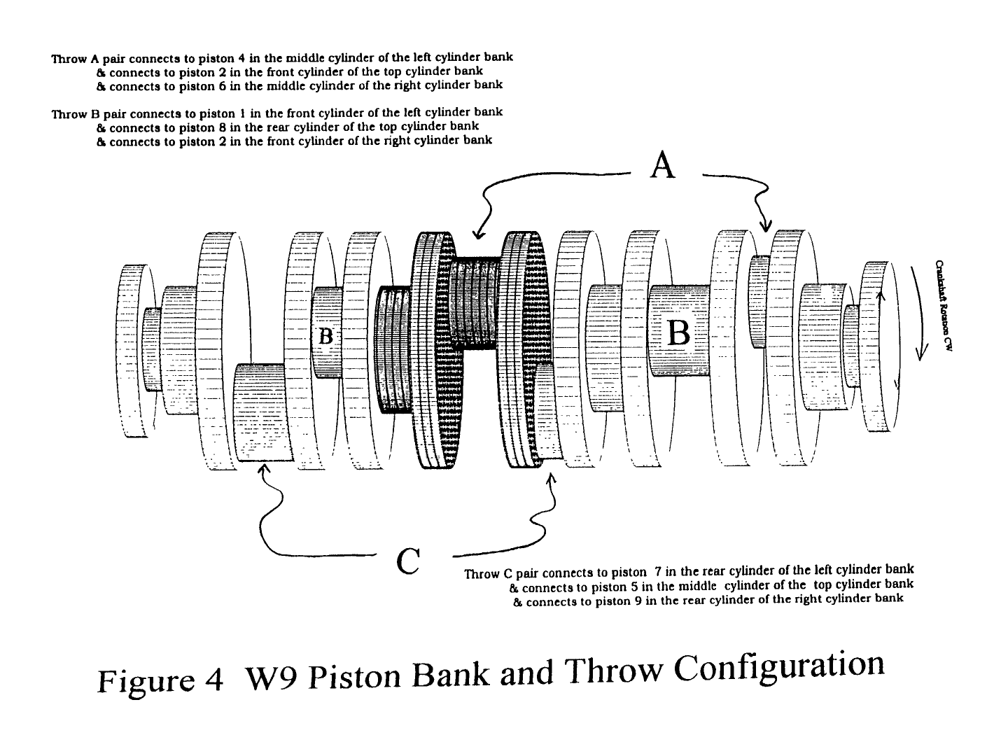

Each cylinder contains a piston that connects drivingly to a crankshaft. All pistons in one in-line bank are drivingly attached to that crankshaft offset at an angle of 120 degrees from each other. The crankshaft throw angles are offset 120 degrees, forming three crankshaft nodes, which is herein referenced as nodes A, B, and C (see FIG. 3). Three of the nine total pistons are connected at each node angle (An example of a crankshaft configuration is shown in FIG. 4).

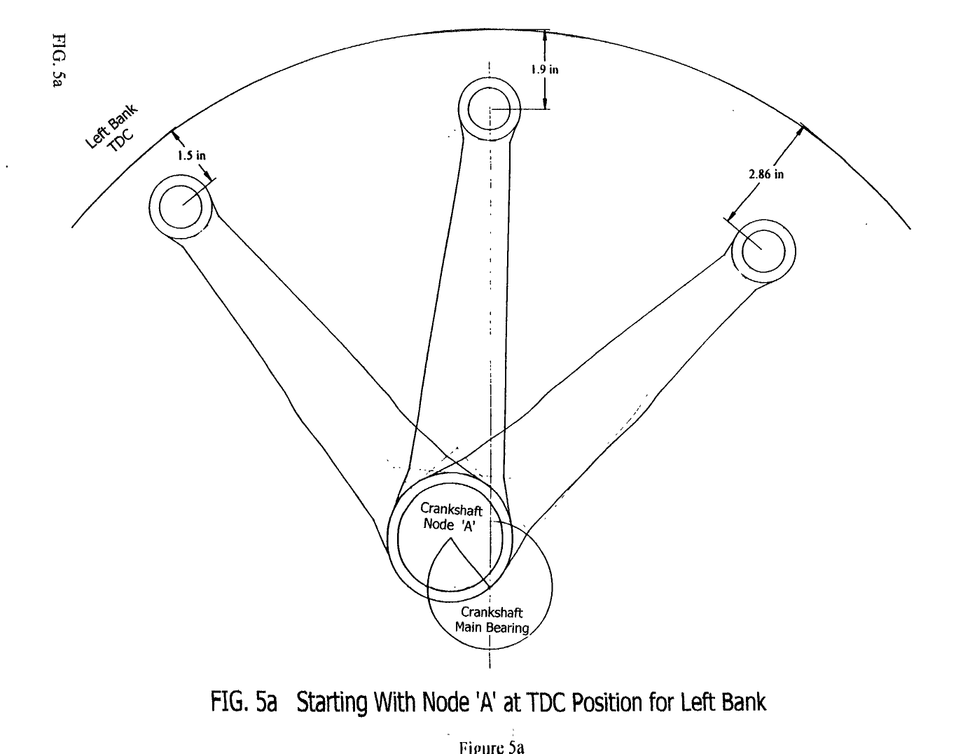

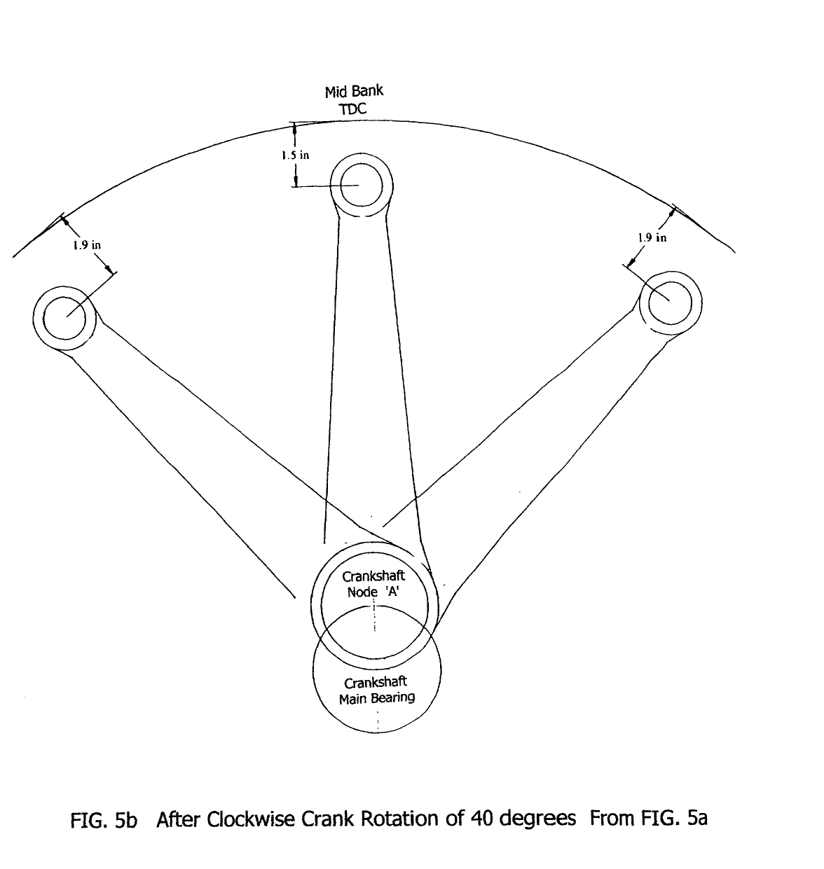

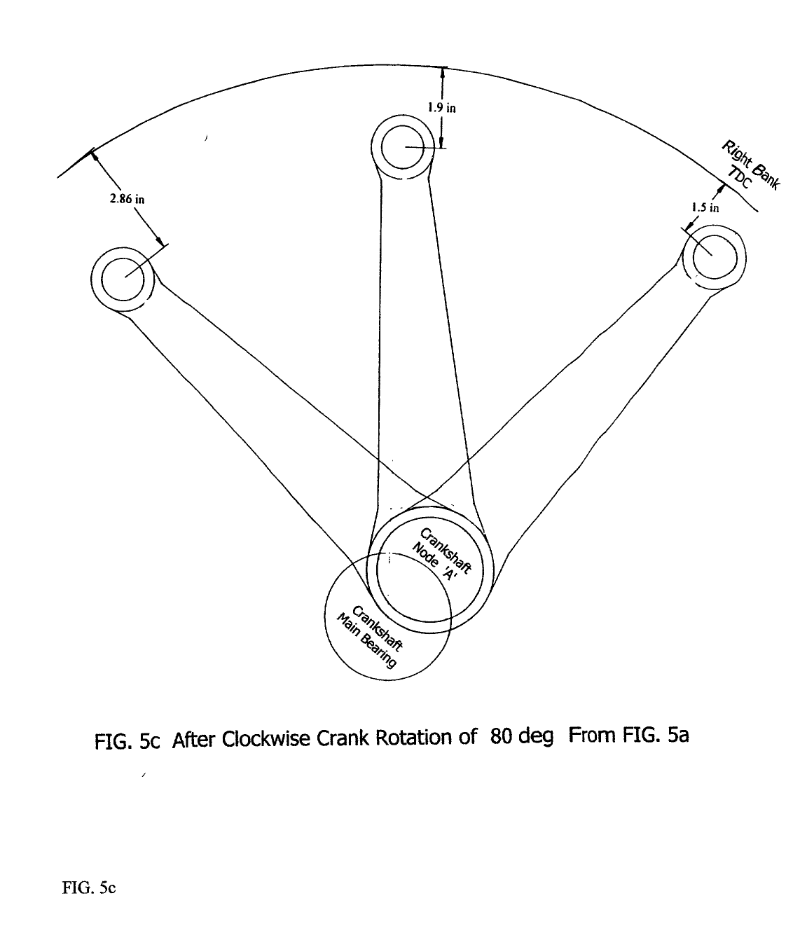

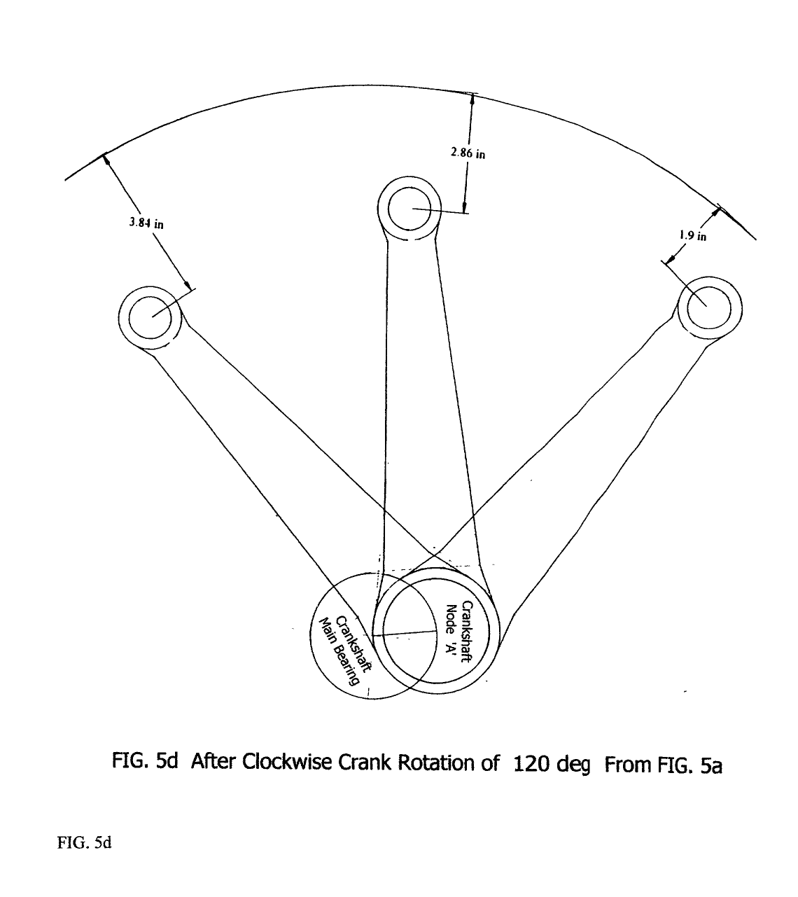

The crankshaft may rotate in either direction. Assuming a clockwise rotation of the crankshaft for the sake of description, and assuming That node ′A' starts initially directly in-line with the left cylinder plane, then one piston from the left bank will be at TDC or Top Dead Center (FIG. 5a). After forty degrees of clockwise rotation of the crankshaft, node ′A' will be in line with the center cylinder plane and a piston from the center cylinder bank will be at TDC (FIG. 5b). Forty more degrees of clockwise rotation will bring node A in line with the right Cylinder plane and a piston from the right cylinder bank will be at TDC (FIG. 5c). Forty more degrees of clockwise rotation (120 degrees total) will bring node B in-line with the left cylinder plane. At that point, the nodes could be re-lettered and the description can continue as above with the next node.

In FIG. 5d, node ′B' is 120 degrees behind node ′A' at TDC in the left bank. These angles are approximate since the crankshaft may not be placed at the exact intersection of all axes of the cylinders deriving from an attempt to lessen side thrust piston to cylinder wear by offsetting the crankshaft toward the side of the cylinder wall that will receive the majority of the power stroke side thrust.

I claim:

1. A crankshaft driven piston engine configuration that has three banks of three cylinders configured most closely to a V-six type engine with an additional bank of three in-line cylinders centered on a plane that divides the in-line V symmetrically in half. Either outside bank of three cylinders would therefore form a V-six type engine when taken together with the middle, in-line, three cylinder bank. If we imagine a flat plane passing through the diameters of each cylinder throughout the full length of each cylinder in a bank, and did that for each of the three banks, there would be three intersecting geometric planes that intersect along a single line parallel to the centerline of the crankshaft or exactly on the centerline of the crankshaft. For the sake of easy reference, these planes will herein be referred to as the cylinder planes. This engine patent configuration does not absolutely require that the line of intersection of the three aforementioned planes be the exact centerline of the crankshaft. The angle between the cylinder planes is 40 degrees from the middle cylinder plane to each one of the outer cylinder planes. Thus, the angle between the outer cylinder planes is 80 degrees. This patent applies to nine cylinder engine configurations in the aforesaid approximation of a W shaped configuration with a crankshaft that has 120 degrees between throws with all pistons in a particular in-line bank connected to the crankshaft at a different throw angle. This engine has 50% more cylinders than an equivalent bore and stroke 90 degree V-6 engine. It has one more cylinder than a V-8 in slightly less width at 80 degree bank angle versus 90 degrees for the typical V-8 and slightly less length with only 3 in-line cylinders per bank.

2. Each cylinder contains a piston that connects to the crankshaft. All pistons in one in-line bank are offset at an angle of 120 degrees from each other. The throw angles are offset 120 degrees, forming three crankshaft nodes, referenced herein as nodes A, B, and C. Three pistons are connected at each node angle via a conventional connecting rod, one from each of the three banks. There are many combinational ways to accomplish the appropriate crankshaft to piston attachment configuration, all insignificant variations for the purposes of this patent.
The engine crankshaft for this patented configuration can rotate either clockwise or counter clockwise with respect to the view from the arbitrarily specified front of the engine.

3. The configuration is not dependent upon being an internal combustion or an external combustion engine and applies to steam type engines using any working fluids, as well as conventional Otto or Diesel cycles using this patented nine cylinder engine configuration. The present invention makes no mention of heads, valves, fuel system, intake or exhaust systems, or any other system that would be required for operation in a power producing engine. These ancillary systems required to make the engine operated, are typically expected to be more or less conventional and are not discussed further as part of this invention. They are therefore not covered in conjunction with the patentable claims of the present invention.

4. This Engine configuration has a very smooth equal rotation power stroke of every 80 degrees for a four stroke implementation or every 40 degrees in a two cycle implementation. Assuming a two cycle arrangement, every time a piston comes to TDC, which is every forty degrees of rotation, a power stroke will be exerted in symmetrical evenly spaced pulses. For four cycle implementations, a power stroke occurs every other time a piston comes to TDC or equally spaced 80 degree power strokes. In a 4 cycle arrangement, assuming that a power stroke starts in the left bank, an intake stroke will happen forty degrees later in the center bank then a power stroke will occur in the right bank followed by an intake stroke starting in the right bank and finally a power stroke in the center bank followed by an intake stroke in the right bank. Then the process starts all over again with a power stroke in the left bank, etc. For a four stroke engine, if we have pistons one, two, and three attached to crank node ′A' using the piston order presented in the foregoing abstract, with 4, 5 , and 6 attached to crank node ′B' and 7, 8, & 9 attached to crank node ° C, then the piston power stroke sequence (commonly termed as the firing order in Otto or Diesel engines and typically starting with cylinder one) would be 1, 3, 5, 7, 9, 2, 4, 6, & 8 firing all the odd cylinders first and then all the even cylinder in a continuously repeating smooth and symmetric cycle.
